(19) United States
(12) Patent Application Publication
(10) Pub. No.: US 2024/0001348 A1
(43) Pub. Date: Jan. 4, 2024

(54) TERNARY CATALYST FOR CARBON DIOXIDE REDUCTION

(71) Applicant: LOTTE CHEMICAL CORPORATION, Seoul (KR)

(72) Inventors: Myung Gi Seo, Daejeon (KR); Sang Sun Park, Daejeon (KR); Eo Jin Lee, Daejeon (KR); Seung Hee Kang, Daejeon (KR); Hyung Ki Min, Daejeon (KR); Jin Hyuk Cho, Daejeon (KR); Sung Hyun Hong, Daejeon (KR); Soo Young Kim, Daejeon (KR); Sang Hyun Ahn, Daejeon (KR)

(73) Assignee: LOTTE CHEMICAL CORPORATION, Seoul (KR)

(21) Appl. No.: 18/253,282

(22) PCT Filed: Nov. 19, 2021
(86) PCT No.: PCT/KR2021/017091

§ 371 Date: May 17, 2023

(30) Foreign Application Priority Data
Nov. 20, 2020 (KR) 10-2020-0157111

(51) Int. Cl. B01J 23/89; B01J 35/10

(52) U.S. Cl. CPC B01J 23/896; B01J 35/10

(57) ABSTRACT

The present invention relates to a ternary catalyst for carbon dioxide reduction, the catalyst including Au and Cu, and further including In or Mo, wherein the content of In or Mo is 0.1 at % to 3 at %.

### TECHNICAL FIELD

The present invention relates to a ternary catalyst for carbon dioxide reduction.

### BACKGROUND ART

The concentration of carbon dioxide in the atmosphere is increasing due to the widespread use of fossil fuels. Carbon dioxide is a major offender of greenhouse gas that causes global warming, and causes environmental and economic problems. Accordingly, research on carbon capture, utilization and storage technologies capable of reducing the concentration of carbon dioxide in the atmosphere has been actively conducted. In particular, electrochemical carbon dioxide reduction technology can produce economically useful hydrocarbon-based compounds such as carbon mono oxide, formic acid, methanol, and methane, and has an advantage of being able to operate under normal temperature and normal pressure conditions. Among them, carbon monoxide forms a higher market price than other products and is widely applied as a gas precursor for the manufacturing industry. However, since carbon dioxide is a very thermodynamically stable material, and electrochemical conversion technology requires a lot of energy to form intermediates during the reaction and has low energy conversion efficiency due to a competing reaction, hydrogen generation reaction. As a catalyst material that efficiently reduces carbon dioxide to carbon monoxide, Au, Ag, Zn, and Pd are representative. In particular, Au and Ag require a relatively low overvoltage to reduce carbon dioxide and have low hydrogen adsorption energy, so that there is an advantage of being able to suppress the competing reaction, the hydrogen generation reaction. Furthermore, high performance improvements can be expected by controlling an oxidation state, a grain boundary, a facet, and morphology of the catalyst. However, despite a high carbon monoxide conversion rate of these catalytic materials, the catalytic materials are very expensive and have low deposits to cause great difficulties in commercially using electrodes using precious metals.

Recently, in order to reduce a cost problem during the catalyst manufacturing process, research is being actively conducted on the development of catalysts that minimize the used amount of precious metals by mixing inexpensive transition metals. In addition, it has been reported that a selective reduction ratio of carbon dioxide to a specific product may be greatly increased by adjusting the composition ratio through mixing of precious and non-precious metals or by changing specific crystal facets, and a binary catalyst prepared by mixing Au and Cu among them is recognized to be excellent in selective reduction to carbon monoxide. It is reported that when the composition of Au and Cu is adjusted to 3:1, the electronic structure of a d-band center changes, and thus, the binding energy of *COOH (formate) as an intermediate is increased and the desorption energy of *CO is stabilized, but it is still difficult to be determined as a catalyst material with economic feasibility.

### PRIOR ART

### Patent Document

(Patent Document 1) Korean Patent Publication No. 10-2017-0106608

### DISCLOSURE

### Technical Problem

An object of the present invention is to provide a ternary catalyst for carbon dioxide reduction capable of implementing high carbon dioxide reduction efficiency and CO selectivity while having a lower precious metal content.

### Technical Solution

An aspect of the present invention provides a ternary catalyst for carbon dioxide reduction, the catalyst including Au and Cu, and further including In or Mo, in which the content of In or Mo is 0.1 at % to 3 at %.

### Advantageous Effects

According to an embodiment of the present invention, the ternary catalyst for carbon dioxide reduction may implement higher selective conversion efficiency from carbon dioxide to carbon monoxide while having a small Au content. Further, according to an embodiment of the present invention, the ternary catalyst for carbon dioxide reduction may be easily prepared through a simple process, and it is possible to easily control the shape and composition of the catalyst by a plating voltage, a plating time, a change in composition of a plating solution, etc.

### DESCRIPTION OF DRAWINGS

FIG. 1 shows field emission scanning electron microscope (FESEM) images of an Au-Cu-In/CP electrode, an Au-Cu-Mo/CP electrode, an Au-Cu/CP electrode, and an Au-Cu-Fe/CP electrode prepared according to Example 1, Example 2, Comparative Example 1 and Comparative Example 2, respectively.

FIG. 2 shows EDS mapping images of an Au-Cu-In/CP electrode, an Au-Cu-Mo/CP electrode, an Au-Cu/CP electrode, and an Au-Cu-Fe/CP electrode prepared according to Example 1, Example 2, Comparative Example 1 and Comparative Example 2, respectively.

FIG. 3 illustrates faradic efficiency of carbon monoxide produced through electrochemical reduction of carbon dioxide in Experimental Examples using the electrodes of Example 1, Example 2, Comparative Example 1 and Comparative Example 2.

FIG. 4 illustrates partial current densities consumed to generate carbon monoxide according to a voltage to be applied in Experimental Examples using the electrodes of Example 1, Example 2, Comparative Example 1 and Comparative Example 2.

### MODES OF THE INVENTION

In this specification, it will be understood that when a member is referred to as being “on” the other member, the member can be in contact with the other member or another member may also be present between the two members.

Throughout the specification, unless explicitly described to the contrary, when a part “comprises” a component, it is meant that other components can be further comprised without excluding another component.

As a result of research on a cheaper and more efficient catalyst for carbon dioxide reduction, the present inventors have completed the present invention. Specifically, the present inventers completed the present invention by finding that carbon dioxide may be reduced with higher efficiency while reducing the used amount of Au compared to an Au-Cu binary catalyst when prepared a ternary catalyst by introducing additional elements such as In or Mo while using Au and Cu as basic elements.

Hereinafter, the present invention will be described in detail.

An embodiment of the present invention provides a ternary catalyst for carbon dioxide reduction, the catalyst including Au and Cu, and further including In or Mo, in which the content of In or Mo is 0.1 at % to 3 at %.

According to an embodiment of the present invention, the ternary catalyst for carbon dioxide reduction uses Au and Cu elements as basic active elements, but introduces a trace amount (0.1 at % to 3 at %) of an additional element (In or Mo) as an additional active element, thereby implementing significantly improved CO faradic efficiency compared to the Au-Cu binary catalyst.

According to an embodiment of the present invention, the ternary catalyst for carbon dioxide reduction consists of Au, Cu, and In, and the content of In may be 1 at % to 2 at %. Specifically, the ternary catalyst for carbon dioxide reduction consists of Au, Cu, and In, and the content of In may be 1.5 at % to 2 at %.

According to an embodiment of the present invention, the ternary catalyst for carbon dioxide reduction consists of Au, Cu, and Mo, and the content of Mo may be 2 at % to 3 at %. Specifically, the ternary catalyst for carbon dioxide reduction consists of Au, Cu, and Mo, and the content of Mo may be 2.5 at % to 3 at %.

According to an embodiment of the present invention, an element content ratio of Au and Cu in the ternary catalyst for carbon dioxide reduction may be 2:1 to 3:1. Specifically, the element content ratio of Au and Cu in the ternary catalyst for carbon dioxide reduction may be 2.2:1 to 2.8:1. In addition, the Au content of the ternary catalyst for carbon dioxide reduction may be 65 at % to 75 at %. Furthermore, the Cu content of the ternary catalyst for carbon dioxide reduction may be 25 at % to 30 at %.

The ternary catalyst for carbon dioxide reduction according to the present invention may reduce the used amount of Au element by introducing an In or Mo element into the Au-Cu catalyst, thereby reducing the manufacturing cost of the catalyst.

According to an embodiment of the present invention, the ternary catalyst for carbon dioxide reduction may exhibit CO faradic efficiency (@−0.6 V_{RHE}) of 85% or more, or 90% or more. The ternary catalyst for carbon dioxide reduction according to an embodiment of the present invention may exhibit higher CO faradic efficiency than the Au-Cu binary catalyst, and specifically, may exhibit significantly higher CO faradic efficiency than the Au-Cu binary catalyst exhibiting the CO faradic efficiency (@−0.6 V_{RHE}) of about 79%.

According to an embodiment of the present invention, the ternary catalyst for carbon dioxide reduction may be supported on a porous carbon carrier. Specifically, according to an embodiment of the present invention, the ternary catalyst for carbon dioxide reduction may provide an electrode for carbon dioxide reduction supported on the porous carbon carrier.

According to an embodiment of the present invention, the porous carbon carrier may include at least one selected from the group consisting of graphene, graphene oxide, fullerene, carbon nanotube (CNT), carbon nanofiber, carbon nanobelt, carbon nano-onion, carbon nano-horn, activated carbon, graphite, and carbon paper. Specifically, the porous carbon carrier may be carbon paper. More specifically, the ternary catalyst for carbon dioxide reduction may be electrodeposited on the carbon paper to be provided in the form of particles.

According to an embodiment of the present invention, the ternary catalyst for carbon dioxide reduction may have an average particle diameter of 50 nm to 200 nm. The particle diameter of the catalyst may be calculated as an average value of particle diameters of 500 particles per unit area after obtaining images of catalyst particles using a field emission scanning electron microscope (FESEM) device.

An embodiment of the present invention provides a method for preparing a ternary catalyst for carbon dioxide reduction including preparing a precursor solution containing an Au precursor, a Cu precursor, and an In precursor or Mo precursor; immersing a three-electrode terminal or a two-electrode terminal including a working electrode in the precursor solution; and electrodepositing ternary catalyst particles on the surface of the working electrode by applying a voltage to the working electrode.

According to an embodiment of the present invention, the Au precursor is a salt containing an Au element, and Au precursors used in the art may be used without limitation. For example, the Au precursor may be KAuCl₄.

According to an embodiment of the present invention, the Cu precursor is a salt containing a Cu element, and Cu precursors used in the art may be used without limitation. For example, the Cu precursor may be CuSO₄4.

According to an embodiment of the present invention, the In precursor is a salt containing an In element, and In precursors used in the art may be used without limitation. For example, the In precursor may be InCl₃.

According to an embodiment of the present invention, the Mo precursor is a salt containing a Mo element, and Mo precursors used in the art may be used without limitation. For example, the Mo precursor may be Na₂MoO₄.

The content of each of the Au precursor, the Cu precursor, the In precursor, and the Mo precursor in the precursor solution may be appropriately adjusted according to an elemental composition ratio of a desired ternary catalyst. Specifically, the Au precursor, the Cu precursor, the In precursor, and the Mo precursor may be included in the precursor solution by adjusting a molar ratio of active elements in the precursors to correspond to the element composition ratio of the desired ternary catalyst.

According to an embodiment of the present invention, the precursor solution may further include a support precursor and/or a pH adjusting agent. The support precursor may include at least one selected from the group consisting of H₂SO₄, K₂SO₄, NaCl, KNO₃, HCl, and KCl.

According to an embodiment of the present invention, the working electrode may be the porous carbon carrier. Specifically, through the step of electrodepositing the ternary catalyst particles, the ternary catalyst for carbon dioxide reduction may be directly electrodeposited on the porous carbon carrier to be provided in the form of particles.

According to an embodiment of the present invention, the working electrode provided with the ternary catalyst for carbon dioxide reduction provided on the porous carbon carrier may be used as an electrode for carbon dioxide reduction.

According to an embodiment of the present invention, in the step of electrodepositing the ternary catalyst particles, a plating voltage may be −0.5 V to −0.7 V, specifically −0.6 V. In addition, in the step of electrodepositing the ternary catalyst particles, a plating time may be 5 seconds to 600 seconds, specifically 10 seconds, 50 seconds, 100 seconds or 300 seconds, and more specifically 100 seconds.

An embodiment of the present invention provides a carbon dioxide conversion device provided with an electrode including the ternary catalyst for carbon dioxide reduction. According to an embodiment of the present invention, the carbon dioxide conversion device may be an H-type cell in which a negative electrode part and a positive electrode part are separated from each other by a cation exchange membrane.

According to an embodiment of the present invention, a positive electrode electrolyte and a negative electrode electrolyte of the carbon dioxide conversion device may each include a solution containing hydrogen carbonate (HCO₃⁻). In addition, the negative electrode electrolyte in the carbon dioxide conversion device may be saturated with carbon dioxide gas, and the positive electrode electrolyte may be saturated with nitrogen gas.

According to an embodiment of the present invention, the carbon dioxide conversion device may be operated at room temperature, specifically within a temperature range of 25° C. to 35° C. When the carbon dioxide conversion device is operated at a temperature exceeding room temperature, the solubility of the gas saturated in the electrolyte solution is reduced, and thus, the reduction reaction of carbon dioxide may be inhibited.

Hereinafter, the present invention will be described in detail with reference to Examples for specific description. However, Examples according to the present invention may be modified in various forms, and it is not interpreted that the scope of the present invention is limited to Examples described below. Examples of this specification will be provided for more completely explaining the present invention to those skilled in the art.

### Example 1

An Au precursor (5 mM KAuCl₄·xH₂O, Alfa Aesar), a Cu precursor (2.5 mM CuSO₄·5H₂O, Daejung Chemicals & Metals), an In precursor (2.5 mM InCl₃·xH₂O, Alfa Aesar), a support precursor (100 mM KCl, JUNSEI) and a pH adjusting agent (100 mM H₂SO₄, JUNSEI) were added and mixed in deionized water to prepare an Au-Cu-In precursor solution.

Electroplating was performed in a three-electrode cell using carbon paper (MGL 280, Avcarb) made of a carbon material as a working electrode, and using a saturated calomel electrode and a platinum wire as a reference electrode and an auxiliary electrode, respectively. At this time, an Au-Cu-In/CP electrode was obtained by electrodepositing an Au-Cu-In ternary catalyst on carbon paper at a constant voltage of −0.6 V_{SCE} for 100 seconds.

### Example 2

An Au precursor (5 mM KAuCl₄·xH₂O, Alfa Aesar), a Cu precursor (2.5 mM CuSO₄·5H₂O, Daejung Chemicals & Metals), a Mo precursor (2.5 mM Na₂MoO₄·2H₂O, Daejung Chemicals & Metals), a support precursor (100 mM KCl, JUNSEI) and a pH adjusting agent (100 mM H₂SO₄, JUNSEI) were added and mixed in deionized water to prepare an Au-Cu-Mo precursor solution.

Electroplating was performed in a three-electrode cell using carbon paper (MGL 280, Avcarb) made of a carbon material as a working electrode, and using a saturated calomel electrode and a platinum wire as a reference electrode and an auxiliary electrode, respectively. At this time, an Au-Cu-Mo/CP electrode was obtained by electrodepositing an Au-Cu-Mo ternary catalyst on carbon paper at a constant voltage of −0.6 V_{SCE} for 100 seconds.

### Comparative Example 1

An Au precursor (5 mM KAuCl₄·xH₂O, Alfa Aesar), a Cu precursor (2.5 mM CuSO₄·5H₂O, Daejung Chemicals & Metals), a support precursor (100 mM KCl, JUNSEI) and a pH adjusting agent (100 mM H₂SO₄, JUNSEI) were added and mixed in deionized water to prepare an Au-Cu precursor solution.

Electroplating was performed in a three-electrode cell using carbon paper (MGL 280, Avcarb) made of a carbon material as a working electrode, and using a saturated calomel electrode and a platinum wire as a reference electrode and an auxiliary electrode, respectively. At this time, an Au-Cu/CP electrode was obtained by electrodepositing an Au-Cu binary catalyst on carbon paper at a constant voltage of −0.6 V_{SCE} for 100 seconds.

### Comparative Example 2

An Au precursor (5 mM KAuCl₄·xH₂O, Alfa Aesar), a Cu precursor (2.5 mM CuSO₄·5H₂O, Daejung Chemicals & Metals), a Fe precursor (2.5 mM FeSO₄·7H₂O, Daejung Chemicals & Metals), a support precursor (100 mM KCl, JUNSEI) and a pH adjusting agent (100 Mm H₂SO₄, JUNSEI) were added and mixed in deionized water to prepare an Au-Cu-Fe precursor solution.

Electroplating was performed in a three-electrode cell using carbon paper (MGL 280, Avcarb) made of a carbon material as a working electrode, and using a saturated calomel electrode and a platinum wire as a reference electrode and an auxiliary electrode, respectively. At this time, an Au-Cu-Fe/CP electrode was obtained by electrodepositing an Au-Cu-Fe ternary catalyst on carbon paper at a constant voltage of −0.6 V_{SCE} for 100 seconds.

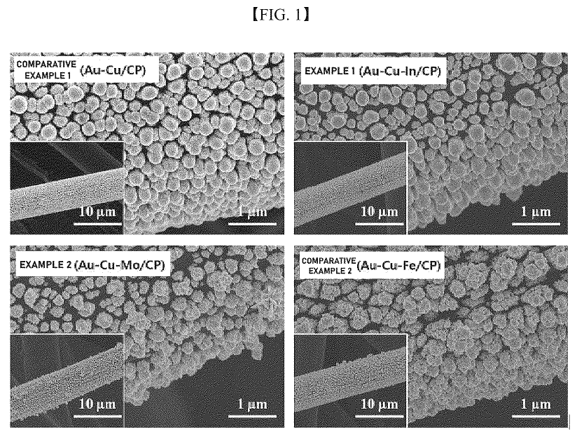

FIG. 1 shows field emission scanning electron microscope (FESEM) images of an Au-Cu-In/CP electrode, an Au-Cu-Mo/CP electrode, an Au-Cu/CP electrode, and an Au-Cu-Fe/CP electrode prepared according to Example 1, Example 2, Comparative Example 1 and Comparative Example 2, respectively. Referring to FIG. 1, it can be confirmed that the electrodes according to Examples and Comparative Examples are provided by electrodepositing catalyst particles on carbon paper in the form of particles.

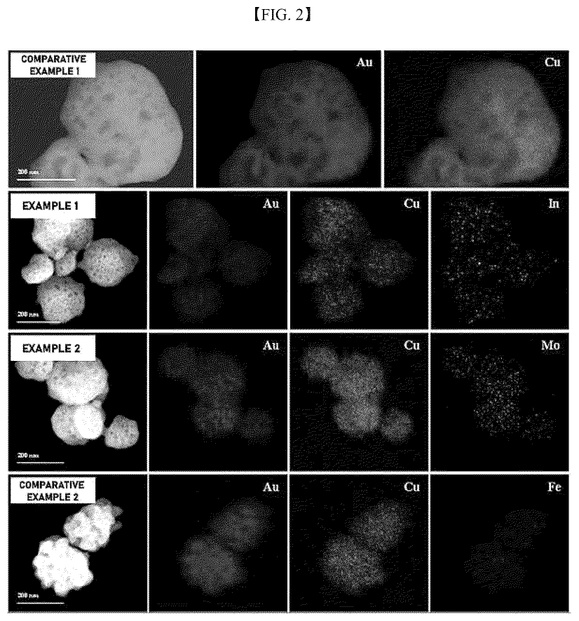

FIG. 2 shows EDS mapping images of an Au-Cu-In/CP electrode, an Au-Cu-Mo/CP electrode, an Au-Cu/CP electrode, and an Au-Cu-Fe/CP electrode prepared according to Example 1, Example 2, Comparative Example 1 and Comparative Example 2, respectively. Referring to FIG. 2, it can be seen that the composition elements of the catalyst particles according to Examples and Comparative Examples are evenly distributed.

### Experimental Example

Electrochemical reduction of carbon dioxide was performed using an Au-Cu-In/CP electrode, an Au-Cu-Mo/CP electrode, an Au-Cu/CP electrode, and an Au-Cu-Fe/CP electrode prepared according to Example 1, Example 2, Comparative Example 1 and Comparative Example 2, respectively. Specifically, an H-type cell was used in which a negative electrode part and a positive electrode part are separated from each other by a cation exchange membrane by using a solution containing hydrogen carbonate (HCO₃⁻) as an electrolyte. Carbon dioxide was injected into the positive electrode electrolyte at 12 mL/min, and voltages of −0.3 V_{RHE} to −0.9 V_{RHE} were applied at 0.1 V intervals for 30 minutes. Gas products generated from the positive electrode part were injected into gas chromatography to analyze compositions thereof, and based on the analyzed compositions, the faradic efficiency of the products was calculated by comparison with charge amounts to be applied.

Table 1 below summarizes the detailed compositions and carbon dioxide reduction test results using the compositions when preparing the electrodes according to Example 1, Example 2, Comparative Example 1 and Comparative Example 2.

TABLE 1

| | | | Example 1 | | Example 2 | | Com. Ex. 1 | | Com. Ex. 2 | |
|---|---|---|---|---|---|---|---|---|---|---|
| | | | [symbol] | | [symbol] | | [symbol] | | [symbol] | |
| | | | 71.5 | | [symbol] | | 70.5 | | 77.1 | |
| Component | Au (at %) | | [symbol] | | 28.7 | | 29.5 | | 16.1 | |
| | Cu (at %) | | 1.7 | | — | | — | | — | |
| | In (at %) | | — | | [symbol] | | — | | — | |
| | Mo (at %) | | — | | — | | — | | [symbol] | |
| | Fe (at %) | | 5 | mM | 5 | mM | 5 | mM | 5 | mM |
| Preparing | Solution | [symbol] | 5 | mM | 5 | mM | 5 | mM | 5 | mM |

| | | | | | | | |
|---|---|---|---|---|---|---|---|
| process | composition | [symbol] | 2.5 | mM | — | — | — |

| [symbol] | — | | 2.5 | mM | — | | — | |
|---|---|---|---|---|---|---|---|---|
| [symbol] | — | | — | | — | | 2.5 | mM |
| KCl | 100 | mM | 100 | mM | 100 | mM | 100 | mM |
| [symbol] | 100 | mM | 100 | mM | 100 | mM | 100 | mM |

| | Plating voltage | [symbol] | | [symbol] | | [symbol] | | [symbol] | |
|---|---|---|---|---|---|---|---|---|---|
| | Plating time | 100 | sec | 100 | sec | 100 | sec | 100 | sec |
| | Temperature | 25° | C. | 25° | C. | 25° | C. | 25° | C. |
| | Pressure | 1 | atm | 1 | atm | 1 | atm | 1 | atm |
| Property | Capacitance | 32.1 | μF/cm² | 65.8 | μF/cm² | 99.5 | μF/cm² | 66.5 | μF/cm² |

| | | | | |
|---|---|---|---|---|
| CO Faradic efficiency | 91.4% | 86.1% | 79.0% | 79.4% |
| [symbol] | | | | |

[symbol]

indicates data missing or illegible when filed

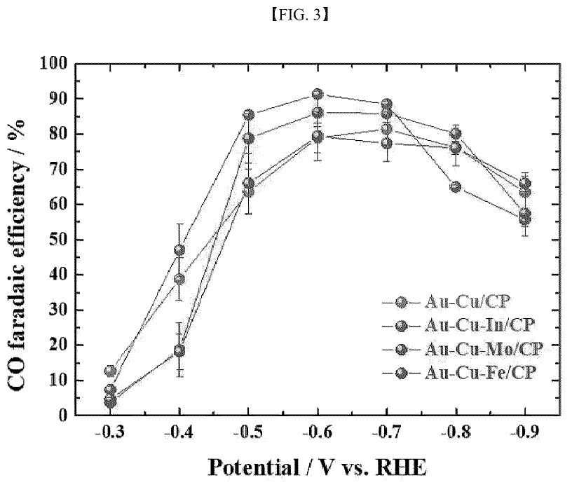

FIG. 3 illustrates the faradic efficiency of carbon monoxide produced through the electrochemical reduction of carbon dioxide in Experimental Examples using the electrodes of Example 1, Example 2, Comparative Example 1 and Comparative Example 2. According to FIG. 3, it can be confirmed that Examples 1 and 2 exhibit superior faradic efficiency compared to Comparative Examples 1 and 2. Specifically, it was confirmed that Examples 1 and 2 exhibited very superior faradic efficiency compared to the Comparative Examples in a voltage range of −0.4 V_{RHE} to −0.7 V_{RHE}. In the case of Example 1 (Au-Cu-In/CP), when the initial −0.3 V_{RHE} voltage was applied, the carbon monoxide conversion efficiency through carbon dioxide reduction was approximately 7.3%, and as the applied voltage increased, the carbon monoxide conversion efficiency increased to exhibit the efficiency of approximately 91.4% at −0.6 V_{RHE}. In addition, on the contrary to the trend of carbon monoxide conversion efficiency, the conversion efficiency of hydrogen production decreased. That is, it was confirmed that the catalyst according to Example exhibited a high carbon dioxide conversion rate, and at the same time, the activity for hydrogen generation was minimized.

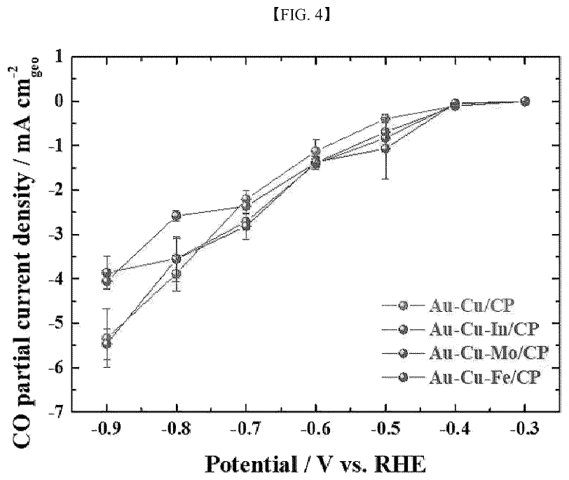

FIG. 4 illustrates partial current densities consumed to generate carbon monoxide according to a voltage to be applied in Experimental Examples using the electrodes of Example 1, Example 2, Comparative Example 1 and Comparative Example 2. According to FIG. 4, it was confirmed that as the applied voltage increased in a negative direction, the partial current density consumed in generating carbon monoxide gradually increased in the negative direction, which corresponded to the result of FIG. 3 described above.

According to the results of Experimental Example above, it can be seen that the ternary catalyst for carbon dioxide reduction according to the present invention exhibits higher carbon dioxide reduction efficiency and hydrogen generation inhibition effect than the existing Au-Cu binary catalysts, and may achieve higher carbon dioxide reduction efficiency than catalysts added with other transition elements such as Fe by applying an In or Mo element.

1. A ternary catalyst for carbon dioxide reduction, comprising Au and Cu, and further comprising In or Mo, wherein a content of the In or Mo is 0.1 at % to 3 at %.

2. The ternary catalyst for carbon dioxide reduction of claim 1, wherein the ternary catalyst consists of Au, Cu and In, in which a content of the In is 1 at % to 2 at %.

3. The ternary catalyst for carbon dioxide reduction of claim 1, wherein the ternary catalyst consists of Au, Cu and Mo, in which a content of the Mo is 2 at % to 3 at %.

4. The ternary catalyst for carbon dioxide reduction of claim 1, wherein an element content ratio of Au and Cu in the ternary catalyst for carbon dioxide reduction is 2:1 to 3:1.

5. The ternary catalyst for carbon dioxide reduction of claim 1, wherein the ternary catalyst for carbon dioxide reduction is supported on a porous carbon carrier.
